(19) United States
(12) Patent Application Publication
(10) Pub. No.: US 2012/0290186 A1
(43) Pub. Date: Nov. 15, 2012

(54) MULTIPLEX CONTROL SYSTEM, TRANSPORT DEVICE HAVING MULTIPLEX CONTROL SYSTEM, AND CONTROL METHOD THEREOF

(75) Inventors: Tien-Ho GAU, Hsinchu City (TW); Cheng-Ho LI, New Taipei City (TW); Kao-Hone CHU, Kaohsiung City (TW); Kai-Ching HSIEH, Taipei City (TW)

(73) Assignee: INDUSTRIAL TECHNOLOGY RESEARCH INSTITUTE, Hsinchu (TW)

(21) Appl. No.: 13/449,015

(22) Filed: Apr. 17, 2012

Related U.S. Application Data
(60) Provisional application No. 61/480,485, filed on Apr. 29, 2011.

(30) Foreign Application Priority Data
Aug. 31, 2011 (TW) 100131381

(51) Int. Cl. G06F 7/00

(52) U.S. Cl. 701/99

(57) ABSTRACT

A conveying device includes a multiplexing control device and power wheels, and the multiplexing control device includes sensors, a bus, a first controller and a second controller. The sensors are used to receive travelling information and output sensing signals. The bus is used to receive the sensing signals and output the sensing signals to the first controller and the second controller. When the conveying device operates, the first controller controls the power wheels according to the sensing signals. If the sensing signals are too complicated, the second controller performs processing together with the first controller. If the first controller is damaged, the second controller replaces the first controller and controls the power wheels according to the sensing signals.

### BACKGROUND

1. Technical Field

The present disclosure relates to a multiplexing control device, and more particularly to a multiplexing control device applied to a vehicle having multiple independent power wheels.

2. Related Art

With the increasing demands on environmental protection, energy saving and low noises, an electric vehicle have attracted more attentions in the industry, as compared with the conventional gasoline and diesel vehicles. In order to improve the transmission efficiency, more and more electric vehicles adopt an in-wheel hub motor. The in-wheel hub motor refers to integrating motor power and tires into a whole without requiring a transmission shaft, a speed changer, a differential gear or other transmission components. In this way, an energy loosed during the power transmission can be avoided.

Although the in-wheel hub motor (or referred to as a power wheel) has the above advantages, the power and the rotation speed output of the power wheels are independent, so a central control system needs to be employed for controlling the wheels in order to meet various running states of the vehicle (for example, differential speed relationship in turning or adjustment of the vehicle speed upper limit according to the power condition). However, when the central control system is overloaded with parameters needed to be processed, the response time of the central control system prolongs due to slow response speed thereof. When the brake is suddenly slammed on for halting the vehicle, the central control system should immediately process the brake signal and drive the vehicle to decelerate in emergency. However, as the central control system is overloaded and therefore, can not process the brake signal immediately for halting the vehicle, accidents may be caused.

In addition, when the central control system breaks down or is damaged as the braking signal is higher than the upper limit capable of being borne by the central control system, the vehicle can only be stopped at roadside and wait for rescue, leaving the driver in an unsafe circumstance.

### SUMMARY

According to an embodiment, a conveying device having a multiplexing control device comprises a main body, multiple power wheels and a multiplexing control device. Each of the power wheels is pivotally connected to a bottom of the main body and comprises a drive motor, and the drive motors are used to drive the power wheels. The multiplexing control device is disposed on the main body, and comprises a bus, multiple sensors, a first controller and a second controller. The sensors are electrically connected to the bus, and are used to receive travelling information generated during operation of the main body and generate multiple sensing signals according to the travelling information. The first controller is electrically connected to the bus and the power wheels. The second controller is electrically connected to the bus and the power wheels.

When the conveying device operates, the first controller controls the power wheels according to the sensing signals, and the second controller continuously detects an operating state of the first controller. When the first controller is damaged, the second controller replaces the first controller and controls the power wheels according to the sensing signals.

According to an embodiment, a conveying device having a multiplexing control device comprises a main body, multiple power wheels and a multiplexing control device. The power wheels are pivotally connected to a bottom of the main body and comprise a drive motor, and the drive motor is used to drive the power wheels. The multiplexing control device comprises a bus, multiple sensors, a first controller and a second driver. The sensors are disposed on the main body, electrically connected to the bus, and used to receive travelling information generated during operation of the main body and generate multiple sensing signals according to the travelling information. The first controller is electrically connected to the bus and the power wheels. The second driver is electrically connected to the bus and the power wheels.

When the conveying device operates, the first controller controls the power wheels according to the sensing signals, and the second driver controls the power wheels according to an instruction of the first controller.

The multiplexing control device of this embodiment is disposed on a conveying device, the conveying device has a main body and multiple power wheels, each of the power wheels is pivotally connected to a bottom of the main body and comprises a drive motor, and the drive motors are used to drive the power wheels. The multiplexing control device comprises a bus, multiple sensors, a first controller and a second controller. The sensors are electrically connected to the bus, and are used to receive travelling information generated during operation of the main body and generate multiple sensing signals according to the travelling information.

The first controller is electrically connected to the bus and the power wheels.

The second controller is electrically connected to the bus and the power wheels.

When the conveying device operates, the first controller controls the power wheels according to the sensing signals, and the second controller continuously detects an operating state of the first controller. When the first controller is damaged, the second controller replaces the first controller and controls the power wheels according to the sensing signals.

### BRIEF DESCRIPTION OF THE DRAWINGS

The present disclosure will become more fully understood from the detailed description given herein below for illustration only, and thus are not limitative of the present disclosure, and wherein:

FIG. 1 is a schematic circuit block diagram of a conveying device having a multiplexing control device according to an embodiment;

FIG. 2 is a schematic enlarged block diagram of a power wheel in FIG. 1;

FIG. 3 is a schematic flow chart of operation of FIG. 1; and

FIG. 4 is a schematic circuit block diagram of a conveying device having a multiplexing control device according to an embodiment.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

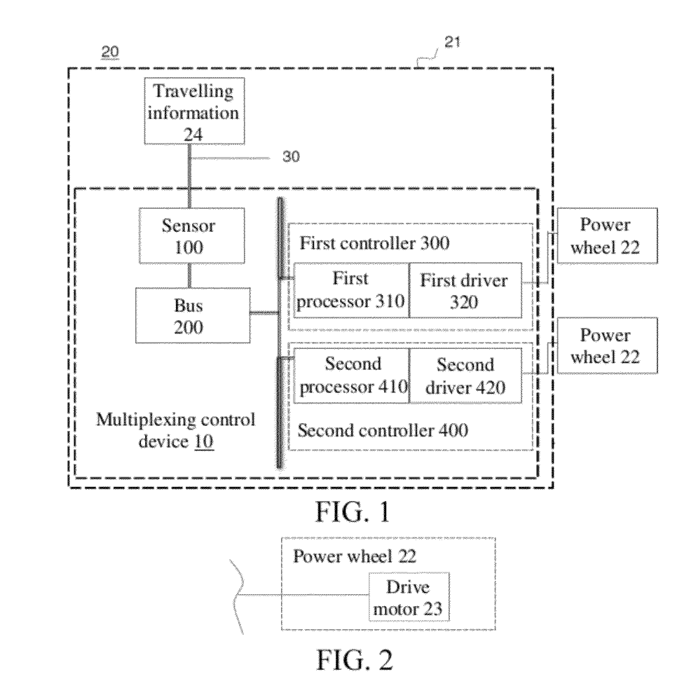

Referring to FIG. 1 and FIG. 2, FIG. 1 is a schematic circuit block diagram of a conveying device having a multiplexing control device according to an embodiment, and FIG. 2 is a schematic enlarged block diagram of a power wheel in FIG. 1.

The conveying device 20 of this embodiment comprises a main body 21, multiple power wheels 22 and a multiplexing control device 10. Each of the power wheels 22 comprises a wheel (not shown) and a drive motor 23. The wheel (not shown) is pivotally connected to a bottom of the main body 21. The multiplexing control device 10 is adapted for receiving travelling information 24 to drive the power wheels 22 to operate, and causing the main body 21 to move under the effect of the rotation of the power wheels 22. Each of the power wheels 22 has a drive motor 23. When the drive motors 23 operate, the power wheels 22 are driven to rotate. It can be seen from FIG. 1 that, the multiplexing control device 10 may control, but not limited to, two power wheels 22 to rotate, and the multiplexing control device 10 may also control less than two or more than two power wheels 22 to rotate. The power wheels 22 of this embodiment are electric power wheels.

The multiplexing control device 10 of this embodiment is disposed on the main body 21 and comprises multiple sensors 100, a bus 200, a first controller 300 and a second controller 400. The sensors 100 are electrically connected to the bus 200, and are used to sense travelling information 24 generated during the operation of the main body 21 and then generate multiple sensing signals according to the travelling information 24. The sensors 100, for example, comprise a steering angle sensor, an acceleration sensor and a deceleration sensor. The steering angle sensor is used to receive a steering intention of a user and output a steering angle signal. The acceleration sensor is used to receive an acceleration intention (or opening of an accelerator pedal) of the user and output an acceleration signal. The deceleration sensor is used to receive a deceleration intention (or opening of a brake pedal) of the user and output a deceleration signal.

The travelling information 24 refers to a state signal or a drive signal returned by the conveying device in travelling. The state signal returned by the conveying device in travelling may be, but is not limited to, a power state, a braking state, a state of a master/slave system, an error reporting state and a diagnostics and vehicle protection state (over current protection, battery low-voltage protection, driver overheating protection and motor overheating protection). The drive signal may be, but is not limited to, acceleration (or referred to as an acceleration signal, an acceleration intention or accelerator opening), deceleration (or referred to as a braking signal or a deceleration intention) and steering (or referred to as a steering angle signal or a steering intention).

The first controller 300 and the second controller 400 are electrically connected to the bus 200 respectively. The first controller 300 comprises a first processor 310 and a first driver 320. A power wheel 22 is electrically connected to the first driver 320. The bus 200 is responsible for I/O reading and controller area network (CAN) connection. The first processor 310 is electrically connected to the bus 200 and is used to calculate the sensing signals to generate a calculation result, and the first driver 320 is electrically connected to the first processor 310 and is used to drive the power wheels 22 according to the calculation result. In other words, the first controller 300 integrates the first processor 310 and the first driver 320 together to reduce a hardware cost, and can process the sensing signals and the outputting signals at the same time to drive the power wheels 22. A structure of the second controller 400 is the same as that of the first controller 300, and also comprises a second processor 410 and a second driver 420, in which a power wheel 22 is electrically connected to the second driver 420. In other words, each controller can control one power wheel 22 to operate. The number of the controllers of the multiplexing control device 10 is not limited to two, and the number of the controllers may also be more than two or less than two, so the multiplexing control device can control more than two or less than two power wheels 22. In addition, each processor has an independent identifier, that is, the first processor 310 has a first identifier, and the second processor 410 has a second identifier.

The sensors 100, the first controller 300 and the second controller 400 are electrically connected to the bus 200 in a manner of a control area network bus (CAN bus) 30.

The first driver 320 and the second driver 420 are respectively controlled by the first processor 310 and the second processor 410 to respectively output operating parameters to drive the power wheel 22. The operating parameter may be, but is not limited to, a drive voltage V, a drive current I and a rotational speed w (or referred to as a wheel rotational speed). The rotational speed may be obtained from a back electro-magnetic field (EMF) of the first driver 320 or the second driver 420. After the drive motors 23 are driven to operate, the first driver 320 or the second driver 420 gets the back EMF. The back EMF may be detected and output in a pulse mode. A physical quantity corresponding to the pulse may be a rotational speed (or referred to as an angular speed) of the drive motor 23. Therefore, at the same time when the first driver 320 or the second driver 420 drives the power wheels 22 to operate, the drive current I, the drive voltage V and the rotational speed w can be output immediately. The first driver 320 and the second driver 420 of this embodiment further output a preset operating parameter corresponding to the drive motor 23, in which the value of the preset operating parameter is fixed, and when the driver stops receiving the signal from the processor, the driver controls the drive motor 23 according to the preset operating parameter.

The rotational speed w is obtained by measuring through the back EMF, and additionally, a part of the drive motors 23 have a built-in Hall Effect sensor. At this time, the first driver 320 may obtain the rotational speed w of the power wheel through measuring by the Hall Effect sensor. The rotational speed w is measured in rotation per minute (rpm) herein, but the present disclosure is not limited thereto.

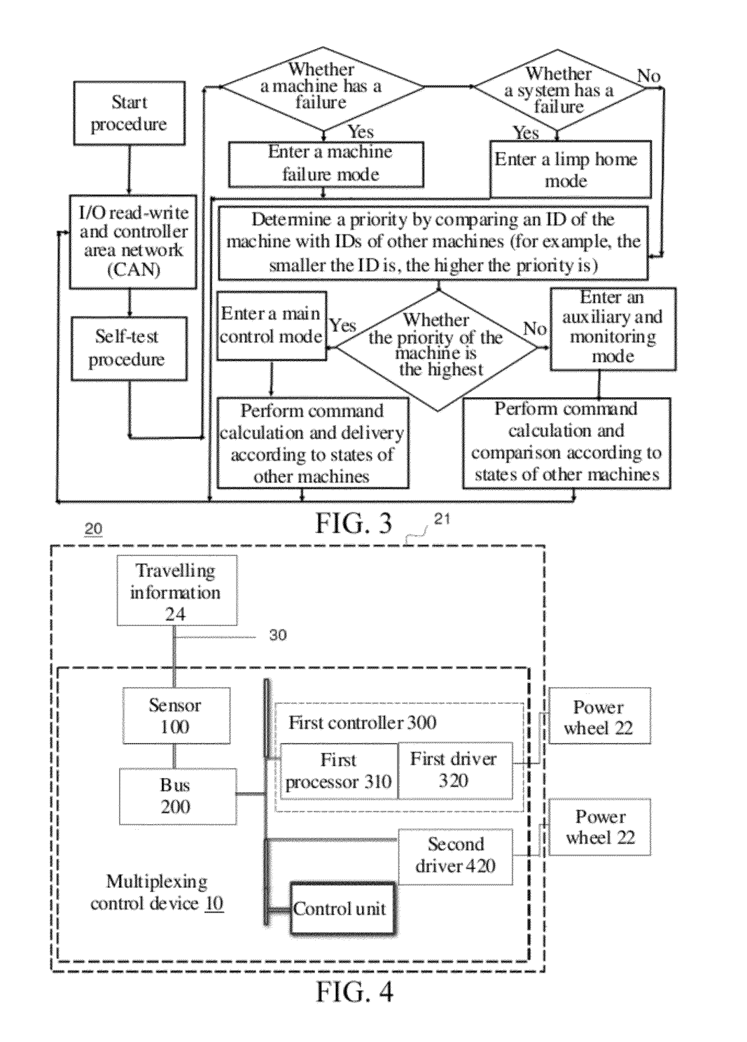

Steps of the first controller 300 cooperating with the second controller 400 in the main body 21 are illustrated in the following. Referring to FIG. 3, FIG. 3 is a schematic flow chart of operation of FIG. 1. First, after the conveying device 20 is started, the bus 200 begins to perform I/O reading, and continuously capture signals output by the sensors 100, the first controller 300 and the second controller 400. Then, a self-test procedure is performed according to the signals. The self-test procedure is that, the first controller 300 and the second controller 400 respectively perform a test procedure, which is described in the following.

First, a condition of the machine is judged, in which the machine refers to the first driver 320 and the second driver 420. The first driver 320 and the second driver 420 comprised by the first controller 300 and the second controller 400 respectively perform a test procedure to detect an operating condition thereof. If a test result at this time is that one of the drivers stops operation, the driver stops driving the drive motor 23 connected to the driver. For example, if the test result is that the first driver 320 stops operation while the second driver 420 operates normally, the first driver 320 stops driving the drive motor 23 connected to the first driver 320, while the second driver 420 normally drives the drive motor 23 connected to the second driver 420.

Afterwards, a system condition is judged, in which the system refers to the first processor 310 and the second processor 410. The first controller 300 of the first processor 310 and the second controller 400 of the second processor 410 respectively perform a detection procedure to detect an operating condition thereof. If the detection result at this time is that one of the processors stop operation, the processor stops controlling the driver connected to the processor. For example, if the detection result is that the first processor 310 stops operation while the second processor 410 operates normally, the first driver 320 stops receiving the signals from the first processor 310 and enters a limp home mode. The limp home mode refers to that the first driver 320 may control the drive motor 23 according to a preset operating parameter pre-stored in the first driver 320. In other words, the limp home mode can ensure that the first driver 320 has the smallest and the safest power output, so that the first driver 320 does not lose power. The second processor 410 continues to normally control the second driver 420.

The test procedure and the detection procedure are performed in a sequence which is not limited to the sequence described in the present disclosure that the test procedure is first performed and then the detection procedure is performed. The detection procedure may also be first performed, and then the test procedure is performed. Or, the test procedure and the detection procedure may also be performed at the same time.

Afterwards, when it is judged that the first controller 300 and the second controller 400 both can operate normally, the first processor 310 and the second processor 410 respectively perform a priority test, so that the first processor 310 and the second processor 410 judge which one is the main controller and which one is the auxiliary controller according to a priority rule. The priority rule of this embodiment is that, the identifiers of all the effective processors in the conveying device 20 are compared with one another, and it is judged that the processor with the smallest identifier is the main controller, and the other processors are the auxiliary controllers. For example, the first processor 310 has a first identifier and the second processor 410 has a second identifier, in which the first identifier is smaller than the second identifier. When the first processor 310 performs the priority test, the first processor 310 compares the first identifier with the second identifier by itself. At this time, since the first identifier is smaller than the second identifier, it is judged that the first processor 310 is the main controller. The second processor 410 also performs the priority test at the same time, but when the second processor 410 compares the second identifier with the first identifier, since the second identifier is greater than the first identifier, it is judged that the second processor 410 is the auxiliary controller. At this time, the second processor 410 continuously monitors the operating state of the first processor 310.

Definitely, the priority rule is not limited to comparing the identifiers of the processors in the present disclosure, and in other embodiments, the priority rule may also be a manner of using a jumper or a manner of software declaring a master-slave relation among control modules.

Then, the condition that the first processor 310 or the second processor 410 suddenly stops operation in the middle of the operation is described in the following. It is supposed that the first processor 310 is the main controller and the second processor 410 is the auxiliary controller. At this time, if the second processor 410 stops operation, the first processor 310 performs the priority test again. However, since the first identifier is still smaller than the second identifier, it is judged that the first processor 310 is still the main controller. At this time, if the first processor 310 stops operation, the second processor performs the priority test again. However, since the second identifier becomes the smallest identifier, it is judged that the second processor 410 replaces the first processor 310 and becomes the main controller. If other processors exist in the conveying device 20, the identifier of the second processor 410 needs to be compared with the identifiers of the other processors, and it is further judged that a processor with the smallest identifier is the main controller.

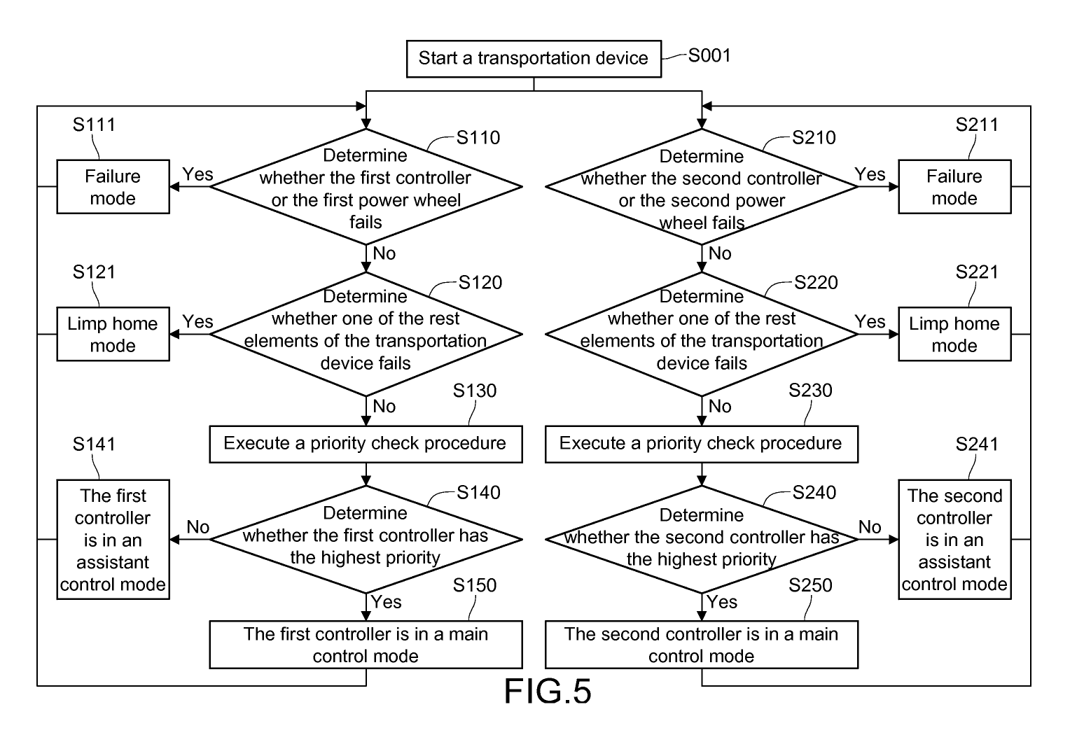

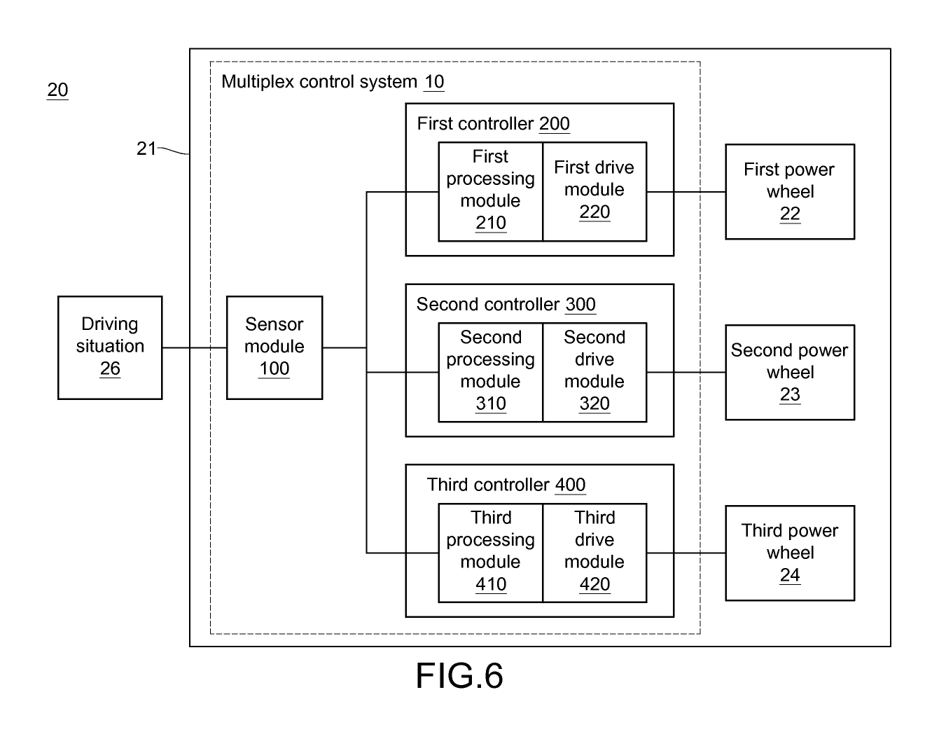

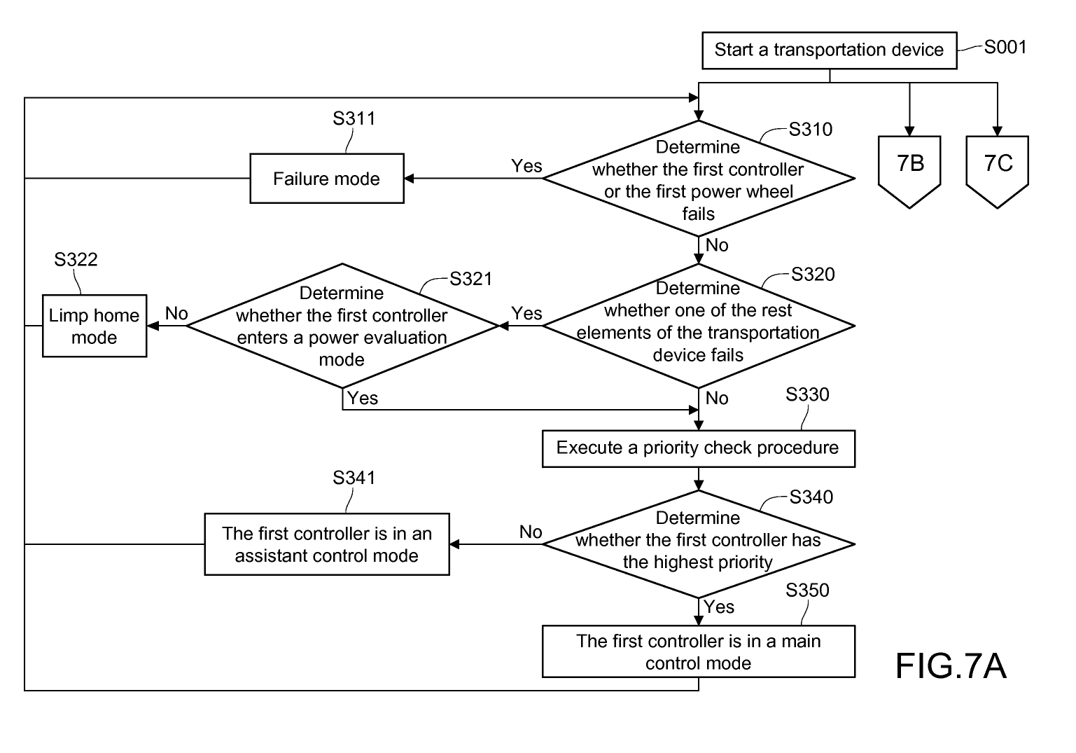

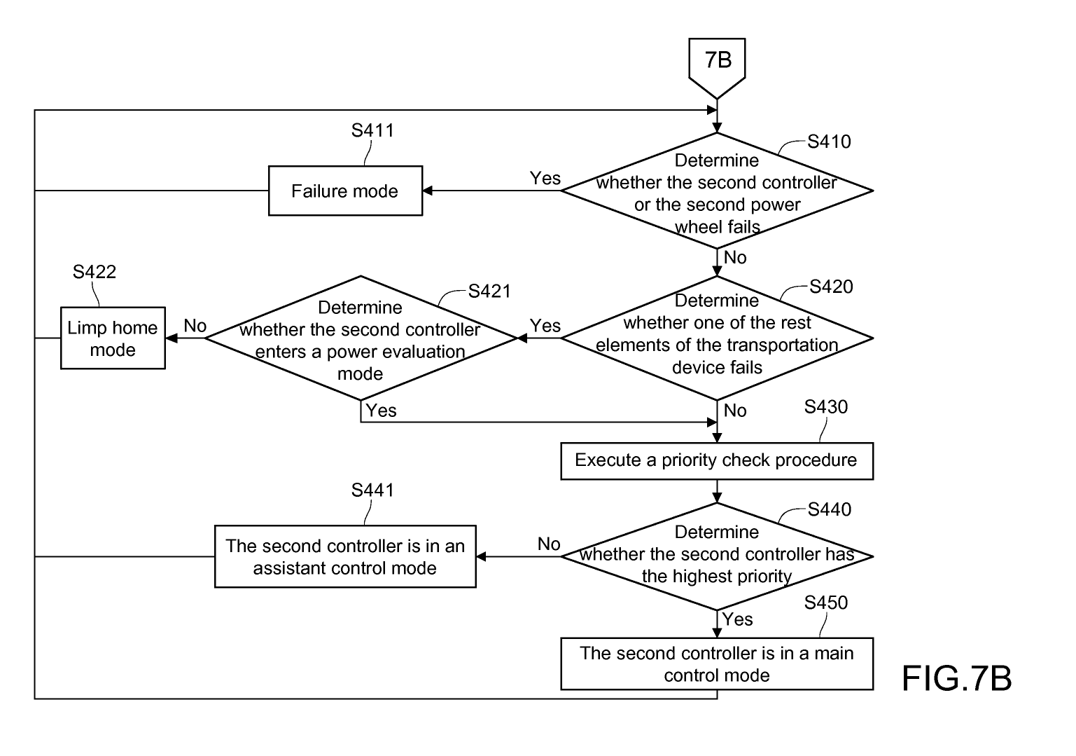

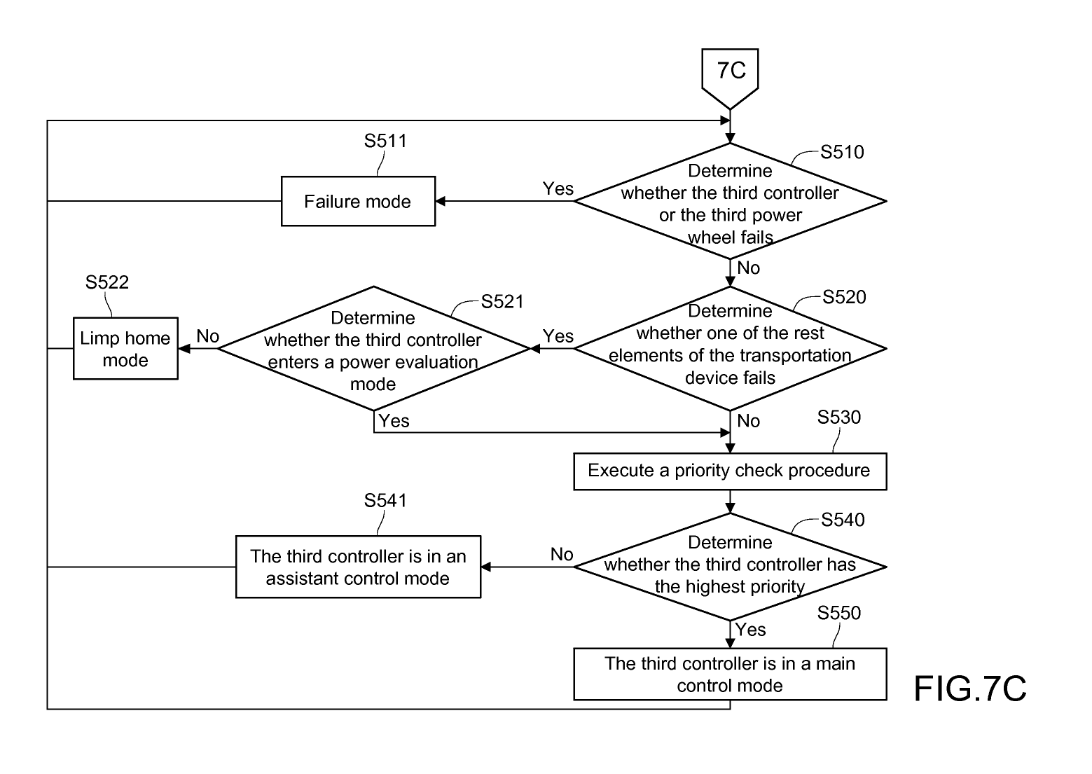

Definitely, in some embodiments, there may be only one first controller 300 installed in a conveying device with only one power wheel. The hardware cost may also be reduced with an electric vehicle without the second controller 400, and further description will be provided in the following through other embodiments. Referring to FIG. 4, FIG. 4 is a schematic circuit block diagram of an electric vehicle having a multiplexing control device according to an embodiment.

The electric vehicle 20 of this embodiment comprises a main body 21, multiple power wheels 22 and a multiplexing control device 10. The structures of the main body 21 and the power wheels 22 are the same as those described in the above, and are not described in detail herein again. The multiplexing control device 10 of this embodiment is disposed on the main body 21 and comprises multiple sensors 100, a bus 200, a first controller 300, one or more other control units 500 and a second driver 420. The sensors 100 are electrically connected to the bus 200, and are used to sense travelling information 24 generated during the operation of the main body 21 and generate multiple sensing signals according to the travelling information 24. The first controller 300 is electrically connected to the bus 200. The first controller 300 comprises a first processor 310 and a first driver 320. The first processor 310 is electrically connected to the bus 200 and is used to calculate the sensing signals to generate a calculation result, and the first driver 320 is electrically connected to the first processor 310 and is used to drive the power wheels 22 according to the calculation result. The second driver 420 is electrically connected to the bus 200 and is used to drive the power wheels 22 according to the calculation result.

According to an embodiment, multiplexing control device and conveying device having the same is through a first controller and a second controller are installed in a central control system, in which the first controller is a main controller responsible for processing main signals and driving the power wheels, and the second controller is a secondary controller responsible for processing signals incapable of being processed by the main controller, so that the central control system can quickly handle complicated control of the car. In addition, when the first controller is damaged, the second controller may be used as the main controller and become a spare part of the central control system, so that the vehicle can continuously travel when the first controller is damaged.

On one hand, the first controller and the second controller integrate the processor and the driver together, so as to reduce the hardware cost. On the other hand, multiple controllers are used together, which can reduce a working load of each controller, thereby decreasing specification requirements of each controller and reducing the cost of the controller.

If new controllers need to be added, it is merely required to electrically connect the controllers to the bus, so that the bus brings about the convenience of expanding the controllers.

What is claimed is:

1. A transport device having a multiplex control system, comprising:
a body, comprising a first power wheel and a second power wheel which are respectively pivoted to a bottom of the body; and
a multiplex control system, disposed in the body, comprising:
a sensor module for sensing a driving situation of the body, and outputting multiple sensor signals according to the driving situation;
a first controller electrically connected to the first power wheel; and
a second controller electrically connected to the second power wheel;
wherein when the transport device is in operation, the first controller generates a first power output value and a second power output value according to the sensor signals, and drives the first power wheel according to the first power output value and sends the second power output value to the second controller, and the second controller drives the second power wheel according to the second power output value.

2. The transport device having the multiplex control system according to claim 1, wherein the first controller comprises a first processing module and a first drive module, the first processing module generates the first power output value according to the sensor signals, and the first drive module drives the first power wheel according to the first power output value.

3. The transport device having the multiplex control system according to claim 1, wherein the second controller comprises a second processing module and a second drive module, the second processing module controls the second drive module to drive the second power wheel according to the second power output value.

4. The transport device having the multiplex control system according to claim 1, further comprising a third controller, wherein the body comprises a third power wheel, the first controller generates a third power output value according to the sensor signals, the third controller comprises a third processing module and a third drive module, the third processing module controls the third drive module to drive the third power wheel according to the third power output value.

5. The transport device having the multiplex control system according to claim 1, wherein the sensor module comprises:
a steering angle sensor for sensing a steering state of the body and outputting a steering angel signal;
an accelerator pedal sensor for sensing an accelerating state of the body and outputting an accelerating signal;
a brake pedal sensor for sensing a decelerating state of the body and outputting a decelerating signal; and
a vehicle speed sensor for sensing a vehicle speed state of the body and outputting a vehicle speed signal.

6. A control method of a transport device having a multiplex control system, comprising:
starting a transport device, wherein the transport device comprises a body, a sensor module, a first controller and a second controller, and the body comprises a first power wheel and a second power wheel;
sensing a driving situation of the body through the sensor module, and outputting multiple sensor signals according to the driving situation;
generating a first power output value and a second power output value through the first controller according to the sensor signals;
driving the first power wheel through the first controller according to the first power output value; and
driving the second power wheel through the second controller according to the second power output value.

7. The control method of the transport device having the multiplex control system according to claim 6, wherein after the step of sensing the driving situation of the body through the sensor module and outputting the sensor signals according to the driving situation, the control method further comprises:
generating a third power output value through the first controller according to the sensor signals; and
driving a third power wheel through a third controller according to the third power output value.

8. The control method of the transport device having the multiplex control system according to claim 6, wherein after the step of starting the transport device, the control method further comprising a check procedure, and the check procedure comprises:
determining whether the first controller or the first power wheel fails;
if the first controller or the first power wheel fails, determining that the first controller is in a failure mode, wherein the failure mode is that the first controller cannot drive the first power wheel; and
if none of the first controller and the first power wheel fails, generating the first power output value and the second power output value according to the sensor signals, and driving the first power wheel according to the first power output value.

9. The control method of the transport device having the multiplex control system according to claim 8, wherein after the step of determining whether the first controller or the first power wheel fails, the control method further comprises:
determining whether one of the rest elements of the transport device fails;
if one of the rest elements fails, the first controller entering a power evaluation mode, wherein the power evaluation mode is evaluating whether the transport device needs to re-distribute the power, and if the transport device needs to re-distribute the power, executing a priority check procedure; if the transport device does not need to re-distribute the power, the first controller entering a limp home mode, wherein the limp home mode refers to that the first controller drives the first power wheel according to a preset output value lower than the first power output value; and
if none of the rest elements fails, the first controller executing the priority check procedure.

10. The control method of the transport device having the multiplex control system according to claim 9, wherein the step of executing the priority check procedure comprises:
determining whether the first controller has the highest priority;
if the first controller has the highest priority, the first controller entering a main control mode and being responsible for generating the first power output value and the second power output value according to the sensor signals; and
if the first controller does not have the highest priority, the first controller entering an assistant control mode and being responsible for receiving a power output value output by a controller in the main control mode.

11. The control method of the transport device having the multiplex control system according to claim 10, wherein the step of determining whether the first controller has the highest priority further comprises:
comparing an identification (ID) code of the first controller and an ID code of the second controller, and if the first controller has a minimum ID code, the first controller entering the main control mode.

12. The control method of the transport device having the multiplex control system according to claim 10, wherein the step of determining whether the first controller has the highest priority further comprises:
comparing an ID code of the first controller and an ID code of the second controller, and if the first controller has a largest ID code, the first controller entering the main control mode.

13. The control method of the transport device having the multiplex control system according to claim 8, wherein the check procedure comprises:
determining whether the second controller or the second power wheel fails;
if the second controller or the second power wheel fails, determining that the second controller is in a failure mode, wherein the failure mode is that the second controller cannot drive the second power wheel; and
if second controller or the second power wheel does not fail, generating the first power output value and the second power output value according to the sensor signals and driving the second power wheel according to the second power output value.

14. The control method of the transport device having the multiplex control system according to claim 13, wherein after the step of determining whether the second controller or the second power wheel fails, the control method further comprises:
determining whether one of the rest elements of the transport device fails;
if one of the rest elements of the transport device fails, the second controller entering a power evaluation mode, wherein the power evaluation mode is evaluating whether the transport device needs to re-distribute the power, and if the transport device needs to re-distribute the power, executing a priority check procedure, if the transport device does not need to re-distribute the power, the second controller entering a limp home mode, wherein the limp home mode refers to that the first controller drives the first power wheel according to a preset power output value lower than the first power output value; and
if no rest element of the transport device fails, the first controller executing the priority check procedure.

15. The control method of the transport device having the multiplex control system according to claim 14, wherein the step of executing the priority check procedure comprises:
determining whether the second controller has the highest priority;
if the second controller has the highest priority, the second controller entering a main control mode and is responsible for generating the first power output value and the second power output value according to the sensor signals; and
if the second controller does not have the highest priority, the second controller entering an assistant control mode and being responsible for receiving a power output value output by a controller in the main control mode.

16. The control method of the transport device having the multiplex control system according to claim 15, wherein the step of determining whether the second controller has the highest priority further comprises:
comparing an ID code of the first controller and an ID code of the second controller, and if the second controller has a minimum ID code, the second controller entering the main control mode.

17. The control method of the transport device having the multiplex control system according to claim 15, wherein the step of determining whether the second controller has the highest priority further comprises:
comparing an ID code of the first controller and an ID code of the second controller, and if the second controller has a largest ID code, the second controller entering the main control mode.

18. A multiplex control system, disposed on a body, wherein the body comprises a first power wheel and a second power wheel, the multiplex control system comprising:
a sensor module, for sensing a driving situation of the body and output multiple sensor signals according to the driving situation;
a first controller, comprising a first processing module and a first drive module, wherein the first processing module controls the first drive module to drive the first power wheel according to the first power output value; and
a second controller, comprising a second processing module and a second drive module, wherein the second processing module controls the second drive module to drive the second power wheel according to the second power output value.

19. The multiplex control system according to claim 18, further comprising:
a third controller, comprising a third processing module and a third drive module, wherein the third processing module controls the third drive module to drive the third power wheel according to a third power output value.
